(19) United States
(12) Patent Application Publication
(10) Pub. No.: US 2015/0154707 A1
(43) Pub. Date: Jun. 4, 2015

(54) System And Method For Recommending Equity Investments

(71) Applicant: Vincent Nahum, Neuilly-sur-Seine (FR)

(72) Inventor: Vincent Nahum, Neuilly-sur-Seine (FR)

(21) Appl. No.: 14/560,619

(22) Filed: Dec. 4, 2014

Related U.S. Application Data
(60) Provisional application No. 61/911,789, filed on Dec. 4, 2013.

(51) Int. Cl. G06Q 40/06

(52) U.S. Cl. CPC G06Q 40/06

(57) ABSTRACT

Interface, system, and method for recommending contextual equity investments based on rankings of a target investment relative to one or more investment strategies. For example, the rankings may include such investment strategies as “Quality,” “Value,” “Momentum,” “Growth,” “Dividend Yield,” or other recognizable strategies. A target investment chosen by the investor is displayed along with its rankings for one or more strategies, and at least one investment opportunity is displayed for each strategy. Each opportunity may have a ranking in the strategy for which it is recommended that exceeds the corresponding ranking for the target equity, and in each other strategy that is at least equal to the corresponding rankings for the target equity.

### FIELD OF THE INVENTION

The disclosure relates to the field of finance and equity investments, and in particular relates to a system and method for recommending equity investments based upon the rankings of a target equity investment.

### BACKGROUND OF THE INVENTION

Professional equity investment involves conducting in-depth financial analysis to select stocks matching investment objectives. Retail investors usually have neither the knowledge nor the tools necessary to perform such an analysis themselves.

Retail investors are typically comfortable investing in only the limited number of industry sectors and types of investments that they are familiar with. They are reluctant to expand their universe of investments due to a lack of actionable information they are able to comprehend and a lack of confidence to explore new investment strategies.

The current environment for retail securities brokerages is difficult. In recent times, there has been a decreased interest in financial markets and a decreased appetite for equities, leading to lower trading volumes and increased competition between broker websites.

In this context, brokers have implemented a number of strategies in an attempt to generate more trades, clicks, and time spent on web pages.

For example, comprehensive analyst advice and recommendations may be made available through the trading platform.

Also, additional content for analysis, such as equity data, news, and charting may be provided.

Each of these approaches fails to address the confidence issue that prevents most retail investors from being active investors.

Besides, existing approaches provide static recommendations that are the same for all investors and not dependent on user interactions with the broker website and user investment styles.

Further, there is a desire from brokers to maximize investor clicks and time spent navigating a broker's website to gather investment information, as well as enlarging the universe of investments that a retail investor is willing to consider, in a manner that overcomes the limitations of the prior art.

### SUMMARY OF THE INVENTION

It is accordingly an object of the present invention to provide an interface, system, and method that provides retail investors with equity investment ideas in a consistent, objective, and understandable format.

It is a further object of the invention to make professional financial analysis accessible to retail investors translating it as simple investment strategies and educating them on their investment styles and proposed investment strategies.

It is another object of the invention to propose contextual investment opportunities that are related to an initial target stock chosen by the investor and which have a better ranking than the target stock in the proposed investment strategies.

It is still a further object of the invention to help retail investors to gain the necessary confidence to expand their universe of potential investments, including increasing the number of industry sectors and types of investment strategies that they are willing to consider, thus increasing user interactions with the brokers' trading platform.

It is also another object of the invention to provide an interface through which the investor can navigate through a number of equity investment ideas based on investment rankings in a desired investment strategy.

Other objects of the invention and its particular features and advantages will become more apparent from consideration of the following drawings and accompanying detailed description.

### BRIEF DESCRIPTION OF THE DRAWINGS

FIG. 1 illustrates an example interface according to aspects of the invention.

FIG. 2 illustrates a particular example implementation of the interface shown in FIG. 1, according to aspects of the invention.

FIG. 3 illustrates an example system usable with the interface of FIG. 1, according to aspects of the invention.

FIG. 4 illustrates an example method usable with the interface of FIG. 1, according to aspects of the invention.

FIG. 5 illustrates another implementation of the example interface shown in FIG. 1, according to aspects of the invention.

FIG. 6 illustrates features of the example interface shown in FIG. 5.

FIG. 7 illustrates further features of the example interface shown in FIGS. 5 and 6.

FIG. 8 illustrates an example method usable with the interface shown in FIGS. 1-7.

### DETAILED DESCRIPTION OF THE INVENTION

It will be appreciated by those having ordinary skill in the art that although specific types of securities may be referred to for the purposes of illustration, such as stocks for example, the invention may also be applied to other types of securities or other investments in some implementations.

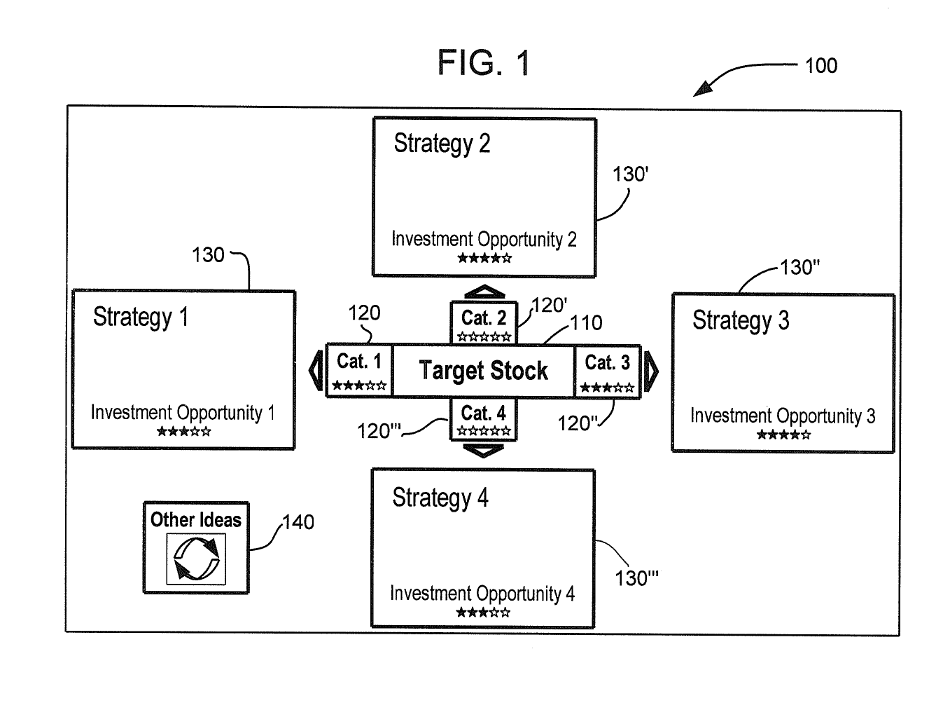

FIG. 1 illustrates an example interface 100 according to aspects of the invention.

Interface 100 may be incorporated into a trading environment, either directly, implemented as a widget, or in another suitable manner. In some implementations, the trading environment includes a webpage, and interface 100 may be displayed in a frame on a webpage (not shown) or as a pop-up (not shown). Interface 100 includes a target stock indicator 110, target stock rankings 120, 120′, 120″, 120′″, investment opportunity indicators 130, 130′, 130″, 130′″, and refresh button 140.

Target stock indicator 110 displays the name of a stock, ticker symbol, or other signifier for a stock of interest.

Target stock rankings 120, 120′, 120″, 120′″ each display a ranking for the stock of interest (shown by indicator 110) in one of four investment strategies. Here, the ranking is shown on a star scale, where the stock is rated in the respective investment strategy on a scale from one to five stars.

Although a star scale ranking system is shown for the sake of example, any suitable ranking scale or system may be used depending upon the desired implementation. For example, the rankings could be provided as a number between one and ten, a letter grade, a thermometer-style graphic, or any other known or suitable ranking scale or system. Furthermore, although four investment strategies are shown for ranking the target stock, target stock rankings could be given for three, or five, or in principle any number of investment strategies. The number of investment strategies is unlimited but can include strategies such as quality, value, momentum, growth, dividend yield, blue chip or other recognizable strategies depending upon the desired implementation.

Investment opportunity indicators 130, 130′, 130″, 130′″ each display an investment opportunity corresponding to one of the four investment strategies shown, along with a ranking for the investment opportunity in that investment strategy.

In typical implementations, an investment opportunity for a particular investment strategy will have a ranking in that investment strategy that is greater than the ranking of the target stock in that same investment strategy. In some implementations, the investment opportunity will also have rankings in other investment strategies that are at least equal to the ranking of the target stock in those investment strategies.

In the example of FIG. 1, target stock ranking 120 indicates that the target stock (shown in indicator 110) has a ranking of two stars in investment strategy 1. Investment opportunity indicator 130 displays an investment opportunity for investment strategy 1, and shows a ranking of the investment opportunity in investment strategy 1 as three stars. In some implementations, the investment opportunity shown by indicator 130 has a ranking in each of investment strategies 2, 3, and 4 that is at least equal to that of the target stock in those investment strategies. In typical implementations, the at least equal ranking in each other investment strategy is implicit, and not displayed in this view of interface 100. However, in some implementations the investment opportunity shown by a given indicator 130, 130′, 130″, 130′″ may show a ranking in other investment strategies, or all investment strategies, without departing from the invention (not shown). It should be noted that in some implementations it is possible that no rankings are displayed directly to the user in the form or stars or the like, but that the rankings are implicit in the relationships among the target stock and investment opportunities.

In some implementations, investment opportunity indicators 130, 130′, 130″, 130′″ are selectable, for example by clicking with a mouse, using another pointing device such as a touch-screen, or via a keyboard (not shown). Any suitable type of selection known in the art may be used without departing from the invention.

When stock indicators 130, 130′, 130″, 130′″ are selected, the investor is provided with additional information, purchasing and/or navigation options. Specifically what is presented and how it is displayed can vary depending on the desired implementation. For example, the selection may cause the interface to offer the investor an opportunity to purchase the stock, may display an option to navigate to another part of the website for further information, may set the selected stock as the target stock, or any or all of these options, for example. Those having skill in the art will appreciate that many other permutations are possible without departing from the invention.

In the present example implementation shown in FIG. 1, when one of the investment opportunity indicators 130, 130′, 130″, 130′″ are selected, the target stock interface 110 is updated to reflect the selected stock, target stock rankings 120, 120′, 120″, 120′″ are updated to reflect the respective rankings for the selected stock, and investment opportunity indicators 130, 130′, 130″, 130′″ are repopulated with new investment opportunities based upon the newly updated target stock rankings 120, 120′, 120″, 120′″.

This process of selecting investment opportunities based on a target stock can be repeated as desired, and can have the advantage of allowing a user to navigate through a number of investment ideas to arrive at a stock pick that is iteratively refined based upon a preferred characteristic.

Refresh button 140 can be used to repopulate investment opportunity indicators 130, 130′, 130″, 130′″ with new investment opportunities. For example, if a user were to select button 140, target stock indicator 110 and target stock rankings 120, 120′, 120″, 120′″ would remain unchanged, reflecting the same stock of interest, while investment opportunity indicators 130, 130′, 130″, 130′″ would each be updated with a new investment opportunity.

This can have the advantage of allowing a user to navigate through a number of investment ideas for a particular target stock in each of several investment strategies.

It will be understood that in some implementations, refresh button 140 may be omitted without departing from the invention. Further, in some implementations a separate refresh button or function could be implemented separately for each investment strategy without departing from the invention.

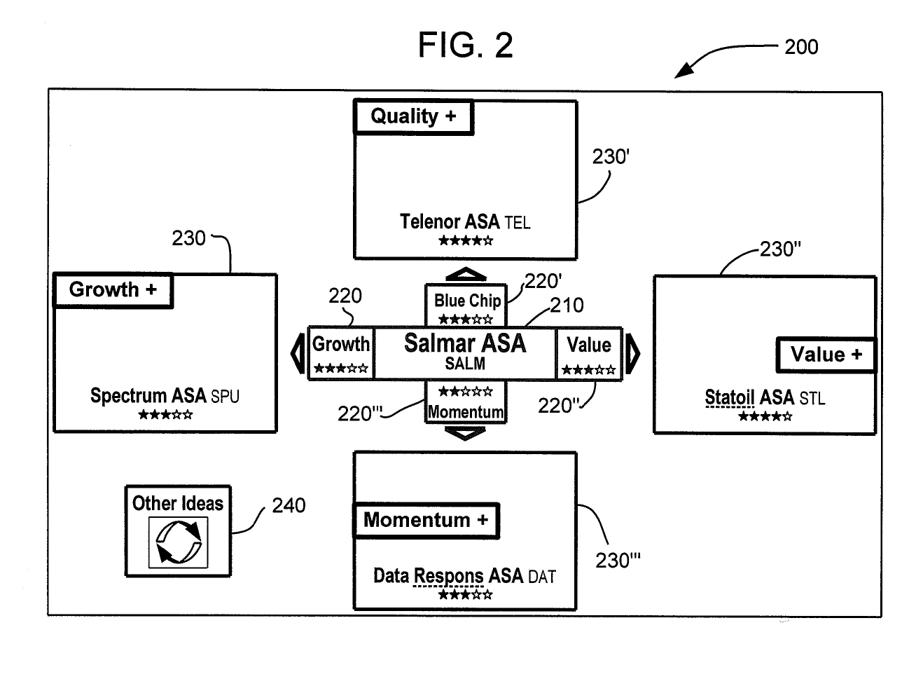

FIG. 2 illustrates a particular example implementation of the interface shown in FIG. 1, according to aspects of the invention.

Interface 200 may be incorporated into a webpage, such as in a trading environment, either directly, implemented as a widget, or in another suitable manner. In some implementations, interface 200 may be displayed in a frame on a webpage (not shown) or as a pop-up (not shown). Interface 200 includes a target stock indicator 210, target stock rankings 220, 220′, 220″, 220′″, investment opportunity indicators 230, 230′, 230″, 230′″, and refresh button 240.

Target stock indicator 210 displays the name and ticker symbol for “Salmar ASA,” a stock of interest in this example.

Target stock rankings 220, 220′, 220″, 220′″ each display a ranking for the stock of interest shown by indicator 210 in one of four investment strategies. Here, rankings 220, 220′, 220″, 220′″ each correspond to investment strategies labeled “Growth,” “Quality,” “Value,” and “Momentum.” In this example, the investment strategies refer to a particular characterization of the investment. Substantial research has been conducted to develop these investment strategies, which correspond to real-world investment styles, and which are easily understandable to retail investors.

For example, a “Growth” investment is typically considered to be an asset having high historical and estimated growth in revenue and profits, and appropriate for a mid- to long-term growth investor.

A “Value” investment, in contrast, is generally considered to be an undervalued asset with a good revaluation probability in the short- to mid-term, and appropriate for a value investor.

A “Quality” investment is typically considered to be a global asset which has a long history, has low volatility and high resilience to market turmoil, low debt exposure, and a history of steady growth and profitability. Quality investments are typically appropriate for long-term investors seeking low risk investments.

A “Momentum” investment, in contrast, is typically an asset with high price and earnings momentum, close to its one-year maximum price, having a high recent stock price increase, high recent earnings estimate revisions. Momentum investments are typically appropriate for short-term and trend-following investors.

Although four investment strategies are shown for ranking the target stock, the number of investment strategies is unlimited—depending upon the desired implementation, any number of strategies considered by an investor could be used. For example, an additional investment strategy (not shown) which could be added without departing from the invention would be “Dividend Yield”, representing investments which typically offer high yields. Those having skill in the art will appreciate that other real-world investment styles can be used as rankings investment strategies in a way that will be understandable to typical retail investors.

The ranking scale used is substantially similar to that described with respect to FIG. 1.

Investment opportunity indicators 230, 230′, 230″, 230′″ each display an investment opportunity corresponding to one of the four investment strategies shown, along with a ranking for the investment opportunity in that investment strategy.

Target stock ranking 220 is shown indicating that the target stock (“Salmar ASA” in this example, shown in indicator 210) has a ranking of two stars in the Growth investment strategy. Investment opportunity indicator 230 displays a recommended Growth stock (“Spectrum ASA” in this example), and shows a ranking of the investment opportunity in the Growth investment strategy as three stars.

In this example, indicator 230 does not display a ranking for Spectrum ASA in the Quality, Value, or Momentum investment strategies. However, depending upon the desired implementation it may be implicit that Spectrum ASA has rankings in these investment strategies that are equal to, or greater than the corresponding rankings of Salmar ASA.

Investment opportunity indicators 230, 230′, 230″, 230′″ are selectable in interface 200, for example, by clicking with a mouse, using another pointing device such as a touch-screen, or via a keyboard (not shown).

If stock indicator 230 is selected, for example, the target stock interface 210 is updated to reflect the Spectrum ASA stock. Target stock rankings 220, 220′, 220″, 220′″ are also updated to reflect the respective rankings for Spectrum ASA. For example, because Spectrum ASA has a three-star rating in the Growth investment strategy, target stock rating 220 will be updated to reflect a three-star rating. Further, investment opportunity indicators 230, 230′, 230″, 230′″ are repopulated with new investment opportunities based upon the newly updated target stock rankings 220, 220′, 220″, 220′″.

This process of selecting investment opportunities based on a target stock can be repeated as desired, and can have the advantage of allowing a user to navigate through a number of investment ideas to arrive at a stock pick that is iteratively refined based upon a preferred characteristic.

Refresh button 240 can be used to repopulate investment opportunity indicators 230, 230′, 230″, 230′″ with new investment opportunities. For example, if a user were to select button 240, target stock indicator 210 and target stock rankings 220, 220′, 220″, 220′″ would remain unchanged, reflecting Salmar ASA as the target stock of interest, while investment opportunity indicators 230, 230′, 230″, 230′″ would each be updated with a new investment opportunity.

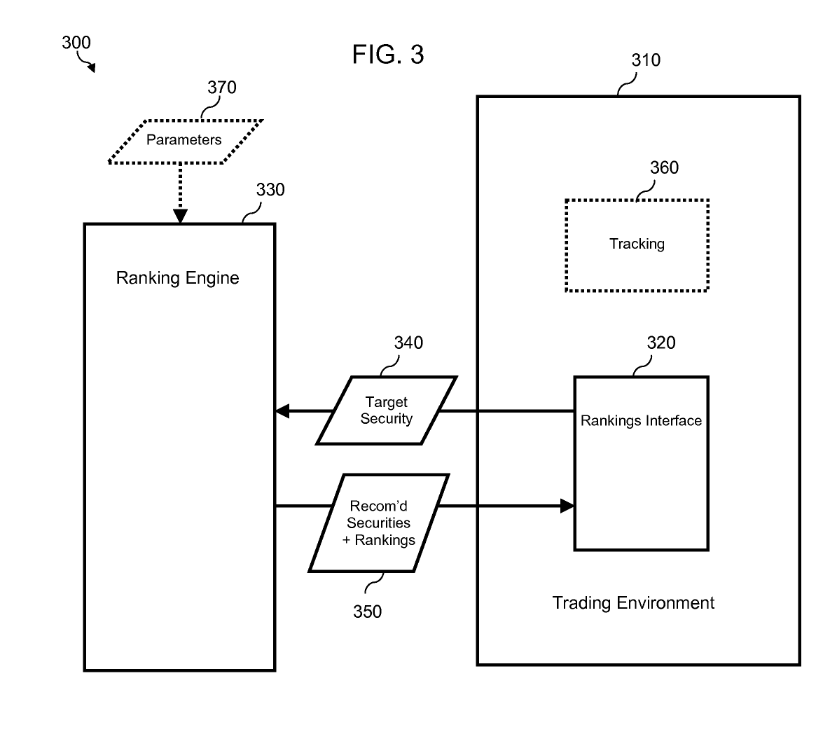

FIG. 3 illustrates an example system 300 according to aspects of the invention, which can be used with the interface of FIG. 1.

System 300 includes a trading environment 310 having a rankings interface 320. The rankings interface can communicate with a ranking engine 330 to transmit information relating to a target security 340 and to receive information relating to one or more recommended securities 350.

Trading environment 310 is an interface through which a customer can engage in trading activity, such as via a broker. In some implementations, trading environment 310 is an online trading website served from a web server computer, although in some implementations any other computer, mobile phone, tablet, application, or other suitable type of interface may be used without departing from the invention. Typically, trading environment 310 will have a number of functions enabling a user to engage in various activities such as security and portfolio analysis, account management, securities trading, and other customary functions, although in some implementations these functions may be omitted without departing from the invention.

Rankings interface 320 is an interface similar to interfaces 100 and 200 described above regarding FIGS. 1 and 2. The rankings interface 320 may be incorporated into the trading environment 310 in a frame, as a pop-up widget, or in any other suitable manner.

In example system 300, trading environment 310 displays rankings interface 320 to the customer. The rankings interface 320 may be displayed at all times, or may be displayed only at certain times or in response to particular events.

For example, trading environment 310 may display rankings interface 320 to the customer when the customer selects a particular stock for analysis (not shown). In this case, the selected stock becomes the target stock of the rankings interface 320. This can have the advantage of assisting the customer in determining how the selected stock ranks as compared to other stocks in a given investment style.

In another example, trading environment 310 may display ranking interface 320 to the customer when preparing to execute a trade. In an example implementation, trading environment 310 may display ranking interface 320 to the customer once the customer has selected a stock to trade. This can have the advantage of helping the user to determine if there are better opportunities for investing prior to executing the trade. Optionally, the ranking interface 320 may be displayed to the customer if the customer delays executing a trade for a certain period of time after selecting a stock to trade. This can have the advantage of providing a user who is hesitating to trade due to indecision with further information which may encourage completion of the trade, or which may encourage the customer to switch to a stock that they are more likely to trade.

In yet another example, trading environment 310 may display ranking interface 320 to the customer after the completion of a trade. In some implementations, the ranking interface 320 may be displayed after completion of a trade only if liquidities remain on the customer's trading account. This can have the advantage of inspiring the customer to engage in additional trades with the remaining liquidities.

In a further example, trading environment 310 may display ranking interface 320 to the customer when the customer is conducting an analysis of their portfolio. This can have the advantage of helping the customer to determine if their portfolio is aligned with their preferred investment style, and if it is not, may encourage additional trading activity to rebalance the portfolio. Optionally, trading environment 310 may display ranking interface 320 to the customer when the ranking of a particular stock has changed. This can have the advantage of apprising the customer of actionable financial information in a timely way, as well as encouraging additional trades.

Trading environment 310 may include tracking functionality, such as user or event tracking software, to facilitate event-driven display of the rankings interface 320, such as in the examples described above. A tracker 360 of this kind may include any known implementation of this functionality, such as JavaScript™ event handling, mouse click and/or move tracking, event tracking and analytics software, page scroll tracking, tracking cookies, or any other suitable means of detecting and responding to user actions or other events such as the passage of time, or changes in stock rankings, for example.

Rankings interface 320 displays a target security, rankings, and recommended securities in substantially the same manner as interface 100 and/or 200, as shown and described with respect to FIGS. 1 and 2.

Information relating to a target security 340 is transmitted from the rankings interface 320 to ranking engine 330. Ranking engine 330 then transmits information relating to recommended securities 350 corresponding to the target security. Rankings interface 320 receives the information 350 and displays the target security, recommended securities, and ranking information in a manner consistent with interface 100 and/or 200 as shown and described with respect to FIGS. 1 and 2.

Ranking engine 330 may be any suitable computing device, such as a personal computer or computer server, which can store information and perform calculations to generate rankings information and recommended securities in response to a selection of a particular target stock. Ranking engine 330 will typically be populated with a set of data relating to a number of securities which can be ranked based on various criteria and from which investment ideas can be proposed.

Ranking engine 330 is also capable of communicating with trading environment 310, for example, over a computer communications network such as the Internet. In some implementations however, ranking engine 330 may be implemented along with trading environment 310 on one device without departing from the invention.

Ranking engine 330 may generate rankings information and recommended securities according to input parameters 370. Parameters 370 may be input by the customer, broker, or another entity to control the ranking and process of selecting investment opportunities.

For example, parameters 370 may be used to select the “universe” or dataset of securities from which investment ideas can be made and for which rankings can be calculated. For example, in some implementations, a broker may wish to present only investment ideas in a particular market sector. In other examples, the customer may choose this, or the parameters may be set by another entity.

Parameters 370 may also be used to control the methodology used to generate rankings and investments ideas. For example, an entity responsible for maintaining the ranking engine 330 may provide one or more particular models or algorithms for generating the investment ideas and rankings to the ranking engine 330. In another example scenario, a broker or customer may choose from among several available models or algorithms by inputting parameters 370. In still another possible implementation, the broker or another entity may modify the algorithms and/or models by inputting parameters 370.

Those having skill in the art will understand that many types of parameters may be input to control the operation of ranking engine 330 without departing from the invention.

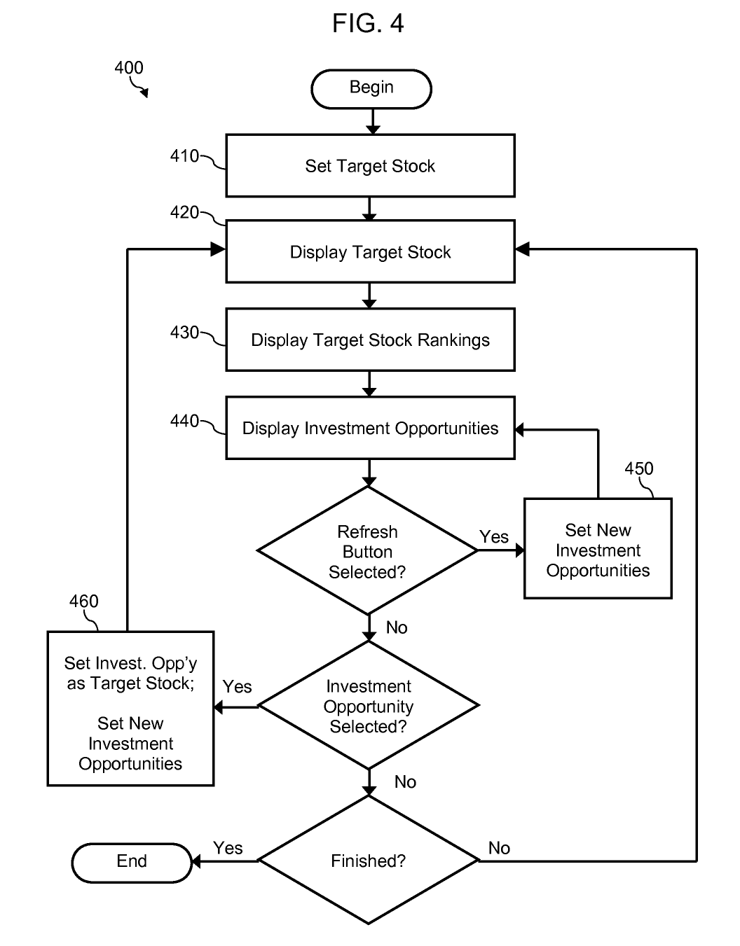

FIG. 4 illustrates an example method 400 according to aspects of the invention, which in some implementations is suitable for use with the interface of FIG. 1.

In step 410, a target stock is set. In some implementations the target stock to set may be selected in a trading environment, for example, as described with respect to FIGS. 1-3.

In step 420, the target stock is displayed, in response to the selection of the target stock. The target stock may be displayed in a rankings interface, for example, such as described with respect to FIGS. 1-3.

In step 430, rankings are displayed for the target stock in each of at least one investment strategy for the target stock in response to the selection of the target stock.

In step 440, at least one selectable investment opportunity is displayed for each investment strategy, having a ranking in that investment strategy that exceeds that of the target stock, and which matches or exceeds the ranking of the target stock in each other investment strategy.

In step 450, if a refresh button is selected, at least one different selectable investment opportunity for each investment strategy having a ranking in that investment strategy that exceeds that of the target stock, and which matches or exceeds the ranking of the target stock in each other investment strategy, is displayed.

In step 460, if a selectable investment opportunity is selected, the selected investment opportunity is set the target stock, rankings in each of the previously mentioned one or more categories are displayed for the new target stock, and at least one selectable investment opportunity for each investment strategy having a ranking in that investment strategy that exceeds that of the new target stock, and which matches or exceeds the ranking of the target stock in each other investment strategy.

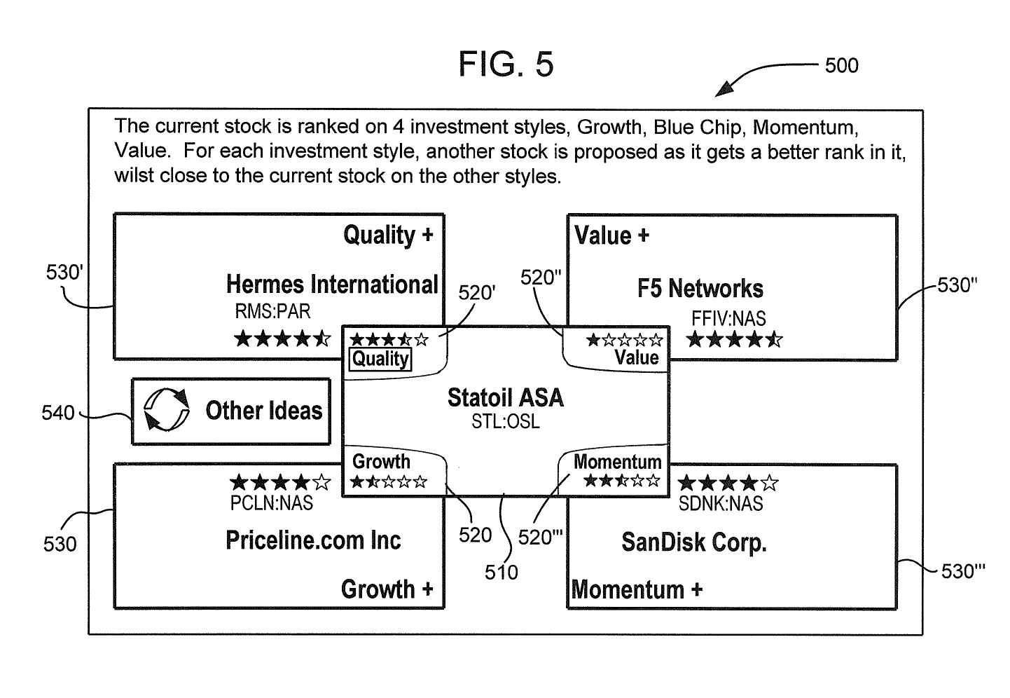

FIGS. 5-7 illustrate another particular example implementation of the interface shown in FIG. 1, according to aspects of the invention.

Interface 500 may be incorporated into a webpage, such as in a trading environment, either directly, implemented as a widget, or in another suitable manner. In some implementations, interface 500 may be displayed in a frame on a webpage (not shown) or as a pop-up (not shown). Interface 500 includes a target stock indicator 510, target stock rankings 520, 520′, 520″, 520′″, investment opportunity indicators 530, 530′, 530″, 530′″, and refresh button 540.

Target stock indicator 510 displays the name and ticker symbol for “Statoil ASA,” a stock of interest in this example.

Target stock indicator 510 includes target stock rankings 520, 520′, 520″, 520′″ each displaying a rating for the stock of interest shown by indicator 510 in one of four investment strategies. Here, rankings 520, 520′, 520″, 520′″ each correspond to investment strategies labeled “Growth,” “Quality,” “Value,” and “Momentum.” In this example, the investment strategies refer to a particular characterization of the investment.

The ranking scale used is substantially similar to that described with respect to FIG. 1.

Investment opportunity indicators 530, 530′, 530″, 530′″ each display an investment opportunity corresponding to one of the four investment strategies shown, along with a ranking for the investment opportunity in that investment strategy.

Target stock ranking 520 is shown indicating that the target stock (“Statoil ASA” in this example, shown in indicator 510) has a ranking of one and a half stars in the Growth investment strategy. Investment opportunity indicator 530 displays a recommended Growth stock (“Priceline.com Inc.” in this example), and shows a ranking of the investment opportunity in the Growth investment strategy as four stars.

In this screen, indicator 530 does not display a ranking for Priceline.com Inc. in the Quality, Value, or Momentum investment strategies.

Refresh button 540 can be used to repopulate investment opportunity indicators 530, 530′, 530″, 530′″ with new investment opportunities. For example, if a user were to select button 540, target stock indicator 510 and target stock rankings 520, 520′, 520″, 520′″ would remain unchanged, reflecting Statoil ASA as the target stock of interest, while investment opportunity indicators 530, 530′, 530″, 530′″ would each be updated with a new investment opportunity.

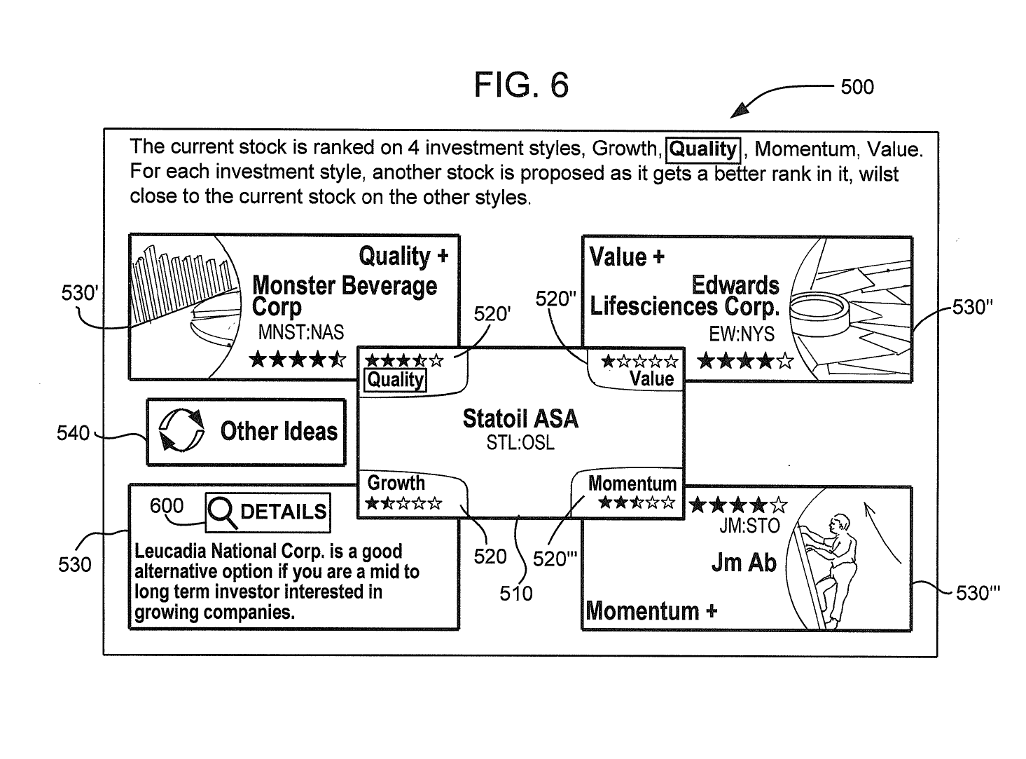

FIG. 6 shows interface 500 wherein refresh button 540 has been pressed. Investment opportunity indicators 530, 530′, 530″, 530′″ are shown repopulated with new investment opportunities, while target stock indicator 510 and target stock rankings 520, 520′, 520″, 520′″ continue to reflect Statoil ASA.

Investment opportunity indicator 530 is also shown in a preselected condition. In this implementation, the display of investment opportunity indicator 530 has been replaced with explanatory information regarding the investment opportunity and/or investment strategy.

Investment opportunity indicators 530, 530′, 530″, 530′″ are pre-selectable in interface 500, for example, by selecting or hovering with a mouse, using another pointing device such as a touch-screen, or via a keyboard (not shown).

A selection button 600 also appears, allowing a user to query additional information about the investment opportunity by pressing selection button 600.

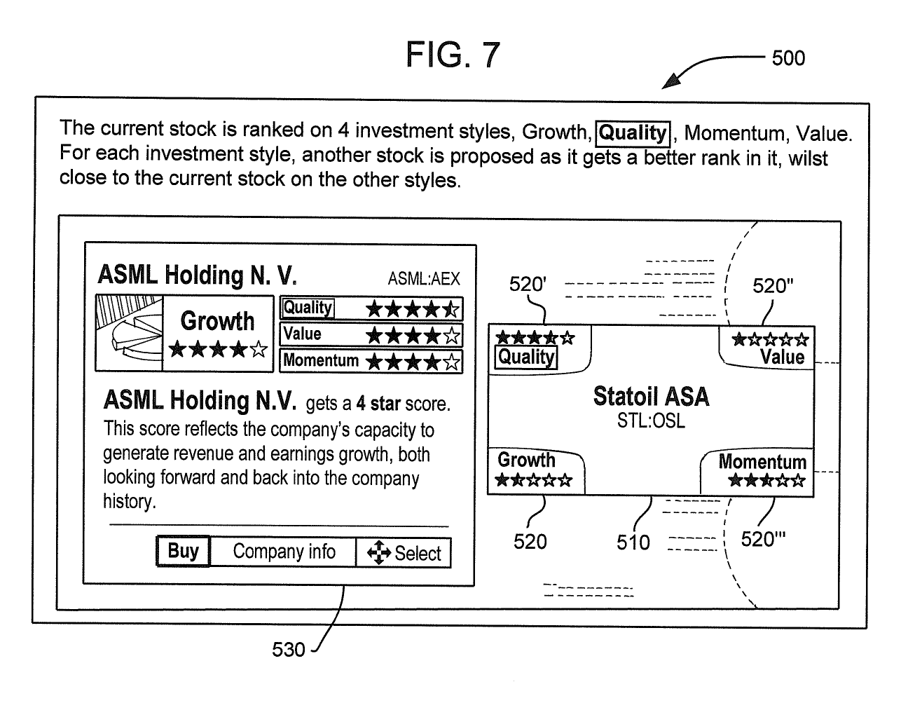

FIG. 7 shows interface 500 after selection of selection button 600. Upon selection, investment opportunity indicator 530 enlarges and displays additional information about the investment opportunity. In this case, the ranking for the investment opportunity in the investment strategy for which it is recommended is shown, as well as the rankings in each of the other investment strategies.

Investment opportunity indicator 530 is shown enlarged, target stock indicator 510 is shown relocated to accommodate the enlarged investment opportunity indicator 530, and investment opportunity indicators 530′, 530″, and 530′″ are darkened and place in the background. This can have the advantage of providing space for further information and action controls, for example, regarding the investment opportunity, and of focusing a user's attention on the selected investment opportunity.

In the example interface 500, the enlarged investment opportunity indicator 530 also displays a purchase control 700, information control 710, and selection control 720. Such controls may be grouped as or otherwise included in an action panel 730.

Purchase control 700 can be selected by the investor to purchase the investment opportunity shown in enlarged investment opportunity indicator 530. Information control 710 can be selected in order to navigate to another part of the website for further information. Selection control 720 can be selected in order to set the investment opportunity as the target stock. Those having skill in the art will appreciate that the action panel 730 and/or controls 700, 710, 720 are customizable. For example, these controls may be omitted, fewer controls could be displayed, or other controls could be added to provide further context dependent or other options or information, without departing from the invention.

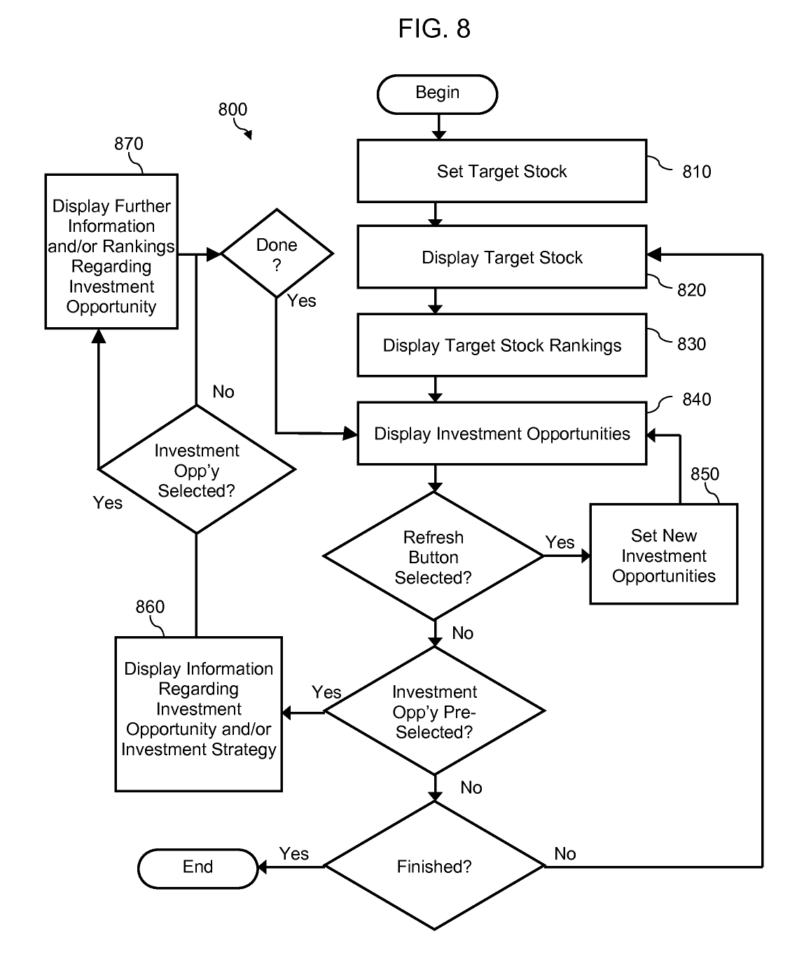

FIG. 8 illustrates another example method 800 according to aspects of the invention, which in some implementations is suitable for use with the interface of FIG. 1. The operation of method 800 corresponds to the example interface shown and described with respect to FIGS. 5-7.

In step 810, a target stock is set. In some implementations the target stock to set may be selected in a trading environment, for example, as described with respect to FIGS. 1-3.

In step 820, the target stock is displayed, in response to the selection of the target stock. The target stock may be displayed in a rankings interface, for example, such as described with respect to FIGS. 1-3.

In step 830, rankings are displayed for the target stock in each of at least one investment strategy for the target stock in response to the selection of the target stock.

In step 840, at least one selectable investment opportunity is displayed for each investment strategy, having a ranking in that investment strategy that exceeds that of the target stock, and which matches or exceeds the ranking of the target stock in each other investment strategy.

In step 850, if a refresh button is selected, at least one different selectable investment opportunity for each investment strategy having a ranking in that investment strategy that exceeds that of the target stock, and which matches or exceeds the ranking of the target stock in each other investment strategy, is displayed.

In step 860, if a selectable investment opportunity is pre-selected, such as by hovering over its display with a mouse pointer, the display of investment opportunity is replaced with explanatory information regarding the investment opportunity and/or investment strategy.

In step 870, if the selectable investment opportunity is selected, such as by clicking a “details” button, (such as element 600 shown and described with respect to FIG. 6) the investment opportunity display enlarges and displays additional information about the investment opportunity. For example, the ranking for the investment opportunity in the investment strategy for which it is recommended may be shown, as well as the rankings in each of the other investment strategies. Other information regarding the investment opportunity may also be displayed (not shown).

Referring to FIGS. 1-8, it will be clear to those having skill in the art that various error conditions may occur without departing from the invention, which are not shown. For example, in a hypothetical dataset that is small in size, a condition may arise where no investment opportunity is available in a given investment strategy for a particular target stock. This may for example be because the target stock has the highest ranking in that investment strategy, and thus there would be no stock having a higher ranking in that investment strategy. In this case, a different stock having the same ranking may be recommended in some implementations. In another hypothetical situation, there may be no stock of equal or higher ranking in a particular investment strategy. In this case, one possible behavior for the system is that no stock would be proposed. Typically, datasets will be large enough to avoid these situations for the most part, but in situations where, for example, extreme constraints are placed on the ranking engine to effect a desired strategy, such conditions may arise. Similar types of infrequent scenarios or special cases may occur without departing from the invention.

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for recommending equity investments comprising:
a server;
at least one database in communication with said server comprising a plurality of financial data for a plurality of investment opportunities;
software executing on said server for generating a ranking engine that provides a ranking for each of the plurality of investment opportunities in a plurality of investment strategies;
software executing on said server for generating a trading environment comprising a rankings interface;
said rankings interface comprising a target stock indicator; at least one target stock ranking indicator; and at least one investment opportunity indicator;
software executing on said server for accepting a user input identifying a target stock;
software executing on said server for identifying at least one investment opportunity with a ranking that exceeds the ranking of said target stock in at least one investment strategy;
software executing on said server for generating target stock data, target stock ranking data, and investment opportunity data; and
software executing on said computer for displaying said target stock data, target stock ranking data, and investment opportunity data through the rankings interface.

2. The system of claim 1 wherein said rankings interface further comprises a refresh button.

3. The system of claim 1 wherein said rankings interface further comprises a refresh button for each target stock ranking indicator.

4. The system of claim 1 wherein said target stock indicator displays at least the name of a target stock and target stock ticker symbol; wherein said target stock ranking indicator displays a ranking for the target stock corresponding to an investment strategy; and wherein said investment opportunity indicator displays an investment opportunity corresponding to the investment strategy and a ranking for the investment opportunity corresponding to the investment strategy.

5. The system of claim 4 wherein said target stock and investment opportunity rankings rank said target stock and investment opportunity using any of a star scale, letter grade, number scale, or thermometer-style graphic.

6. The system of claim 4 wherein said investment opportunity indicator further displays at least one additional ranking for the investment opportunity corresponding to an additional investment strategy.

7. The system of claim 2 wherein activating said refresh button repopulates said at least one investment opportunity indicator with data for a different investment opportunity.

8. The system of claim 3 wherein activating any one of said refresh buttons repopulates the corresponding investment opportunity indicator with data for a different investment opportunity.

9. The system of claim 1 wherein said investment strategies include growth, blue chip, momentum, value, and dividend yield.

10. The system of claim 1 wherein activating said investment opportunity indicator repopulates said target stock indicator and said at least one target stock ranking with data about the selected investment opportunity and repopulates said at least one investment opportunity indicator with a different investment opportunity corresponding to the investment strategy.

11. The system of claim 10 wherein the user can continue to activate said investment opportunity indicator and said system will continue to repopulate said target stock indicator and said at least one target stock ranking with data about the selected investment opportunity and repopulate said at least one investment opportunity indicator with a different investment opportunity corresponding to the investment strategy.

12. The system of claim 1 wherein activating said investment opportunity indicator provides the user with additional data about the investment opportunity.

13. The system of claim 1 wherein activating said investment opportunity indicator provides the user the opportunity to purchase the investment opportunity.

14. The system of claim 1 wherein said rankings interface is displayed once the user selects a stock to trade in said trading environment.

15. The system of claim 1 wherein said rankings interface is displayed once the user has executed a trade in said trading environment.

16. A method for recommending equity investments comprising the steps of:
providing a computer;
providing a database in communication with said computer comprising a plurality of financial data for a plurality of investment opportunities;
generating, via software executing on said computer, a trading environment comprising a rankings interface, said rankings interface comprising a target stock indicator, at least one target stock ranking indicator, and at least one investment opportunity indicator;
receiving, from a user device, user input identifying a target stock;
generating, via software executing on said computer, target stock ranking data for a plurality of investment strategies;
identifying, via software executing on said computer, at least one investment opportunity with a ranking in at least one investment strategy that exceeds the ranking of the target stock in that investment strategy;
generating, via software executing on said computer, data for said at least one investment opportunity;
displaying, via software executing on said computer, target stock data, target stock ranking data, and investment opportunity data through said rankings interface.

17. The method of claim 16 further comprising the step of receiving, from a user device, user input identifying an investment strategy.

18. The method of claim 16 further comprising the steps of:
receiving, from a user device, user input selecting one of said investment opportunity indicators; identifying, via software executing on said computer, the user selection as a new target stock; generating, via software executing on said computer, new target stock ranking data for a plurality of investment strategies; identifying, via software executing on said computer, at least one new investment opportunity with a ranking that exceeds the ranking of the new target stock; generating, via software executing on said computer, data for said at least one new investment opportunity; and displaying, via software executing on said computer, new target stock data, new target stock ranking data, and new investment opportunity data through the rankings interface.

19. The method of claim 16 wherein said rankings interface further comprises a refresh button.

20. The method of claim 19 further comprising the steps of:
receiving, from a user device, user input selecting said refresh button;
identifying, via software executing on said computer, at least one different investment opportunity with a ranking in at least one investment strategy that exceeds the ranking of the target stock in that investment strategy; generating, via software executing on said computer, data for said at least one different investment opportunity;
and displaying, via software executing on said computer, said different investment opportunity data through the rankings interface.

21. A system for recommending equity investments comprising:
a server;
at least one database in communication with said server comprising a plurality of financial data for a plurality of investment opportunities;
software executing on said server for generating a ranking engine that provides a ranking for each of the plurality of investment opportunities in a plurality of investment strategies;
software executing on said server for generating a trading environment comprising a rankings interface;
said rankings interface comprising a target stock indicator; at least one target stock ranking indicator; at least one investment opportunity indicator; and a refresh button;
wherein said target stock indicator displays at least the name of a target stock and target stock ticker symbol;
wherein said target stock ranking indicator displays a ranking corresponding to an investment strategy;
wherein said investment opportunity indicator displays an investment opportunity and at least one ranking for the investment opportunity corresponding to an investment strategy; and
wherein activating said refresh button repopulates said at least one investment opportunity indicator with data for a different investment opportunity;
software executing on said server for accepting a user input identifying a target stock;
software executing on said server for identifying at least one investment opportunity with a ranking that exceeds the ranking of said target stock in at least one investment strategy;
software executing on said server for generating target stock data, target stock ranking data, and investment opportunity data; and
software executing on said server for displaying said target stock data, target stock ranking data, and investment opportunity data through the rankings interface.

22. The system of claim 21 wherein said target stock and investment opportunity rankings rank said target stock and investment opportunity using any of a star scale, letter grade, number scale, or thermometer-style graphic.

23. The system of claim 21 wherein said investment strategies include growth, blue chip, momentum, value, and dividend yield.
